(19) United States
(12) Patent Application Publication
(10) Pub. No.: US 2012/0114412 A1
(43) Pub. Date: May 10, 2012

(54) BALL JOINT

(75) Inventors: Dirk Sokolihs, Bramsche (DE); Sonja Ahlert, Hagen a.T.W. (DE); Frank Grundmann, Westerkappeln (DE)

(73) Assignee: ZF FRIEDRICHSHAFEN AG, Friedrichshafen (DE)

(21) Appl. No.: 13/060,503

(22) PCT Filed: Aug. 11, 2009
(86) PCT No.: PCT/DE09/50043

§ 371 Date: Mar. 17, 2011

(30) Foreign Application Priority Data
Aug. 27, 2008 (DE) 10 2008 041 620.7

(51) Int. Cl. F16C 11/06; B21D 53/10

(52) U.S. Cl. 403/122; 29/898.047

(57) ABSTRACT

A ball joint for a motor vehicle having a housing and a ball pin (2) whose joint ball (3) is rotatably and pivotally supported in a bearing shell (6). The bearing shell (6) has a sheet-metal strip provided with recesses and which is formed for the formation of the bearing shell. A method for producing a component of a bearing shell of a ball joint is also disclosed.

This application is a national stage completion of PCT/EP2009/050043 filed Aug. 11, 2009 which claims priority from German Application Serial No. 10 2008 041 620.7 filed Aug. 27, 2008.

### FIELD OF THE INVENTION

The invention relates to a ball joint and a method for producing such ball joints.

### BACKGROUND OF THE INVENTION

Ball joints, such as the ones used in wheel suspensions of motor vehicles, for example, fundamentally have a similar design. Thus, they are composed of a housing and a ball pin, whose joint ball is rotatably and pivotably received in a bearing shell, which can be formed from a plurality of bearing shell parts. During assembly of a ball joint it must be ensured that as little friction as possible is present between the joint ball and the bearing shell surrounding this. The torque that can be measured at the ball pin when the ball pin is pivoted or rotated out of its neutral position, serves as an indicator of the friction. This torque, in addition to being dependent on the materials used in the bearing shell and the surface of the joint ball, depends on the preloading forces which act, depending on the assembly, originating from the bearing shell on the joint ball and with it on the ball pin and its movability.

Axial joints and radial joints are distinguished, where a decisive criteria for this distinction is the direction of the main forces introduced into the ball joint. If these forces act in a radial direction relative to the longitudinal axis of the housing, which coincides with the longitudinal axis of the ball pin when it is not deflected, a radial joint is assumed. Similarly, in the case of an axial joint, this force introduction occurs mainly in an axial direction.

To some extent, an elasticity of the bearing shell is desirable with ball joints in order to compensate, for example, for movements of the ball pin within the ball joint, within a limited scope, or tolerances.

A multi-part bearing shell produced from a plastic-metal composite, and a ball joint equipped therewith, arises from EP 0 922 868 A2, as an example of an axial joint. Aside from the fact that the bearing shell according to this document has an inherent elasticity and thus yields to movement of the ball pin within certain limits, the described ball joint further additionally has a damping ring.

A further possibility, to implement the bearing shell for a ball joint elastically, consists of inserting a groove and/or slit into the bearing shell. Such a solution is given for example in DE-AS 1 098 377, and is suitable for one-part as well as for multi-part bearing shells.

Beyond that, the document DE 195 45 567 C2 describes a ball joint having a one-part bearing shell which is equipped with a film hinge. According to the disclosed content of the document, the film hinge serves to facilitate the insertion of the joint ball of the ball pin into the bearing shell before the overall unit created this way is inserted into a housing. After assembly of the ball joint, with the film hinge it is possible to guarantee limited yielding of the bearing shell and thus additional elasticity which means that the ball pin is supported movably in the housing crosswise to its longitudinal axis.

In particular, with ball joints having a multi-part bearing shell it can be determined however that sufficient elasticity compensation, with properties defined by the material and the geometry of the bearing shell, with simultaneous satisfactory stability of the bearing shell, is not given with the known solutions.

### SUMMARY OF THE INVENTION

The object of the invention is to provide a ball joint whose bearing shell enables defined elasticity compensation, and thus has automatic reset properties without having to accept a loss with respect to the required stability of the bearing shell. Further, a method is to be specified that enables the production of such a ball joint.

A ball joint for a motor vehicle having a housing and a ball pin whose joint ball is rotatably and pivotably supported in a bearing shell, was further developed according to the invention in that the bearing shell contains a metal strip produced and formed by a separation process, for instance, blanking or punching.

The metal strip has recesses on at least one side, so that prongs or teeth are formed in the bearing shell. The ends of the prongs or teeth, after forming the metal strip into the ball-shaped bearing shell shape, point inwardly towards the center axis of the ball pin. Furthermore, the ends of the prongs or teeth have a spacing.

The recesses or prongs or teeth can be shaped in the form of a V. In this case, the prongs or teeth are pointed. A further favorable shape of the prongs or teeth is a trapezoidal design. Naturally, the recesses too can have a trapezoidal shape.

It has proven to be advantageous if the ratio of the depth of the recesses or prongs or teeth to the width of the spacing of the prongs or teeth is approximately ⅔ to ⅓.

The bearing shell has improved stability due to the metal strip thereat or therein. The combination of elastic properties and higher strength in the bearing shell according to the invention results in frictionally optimized component pairing.

According to one design of the invention it is proposed that the bearing shell is composed of a plurality of bearing shell parts, and that at least one bearing shell part contains a metal strip.

The multi-part embodiment of the bearing shell of a ball joint allows for substantially broader freedom of design for the layout. Thus it is possible, for example to use different materials or material compositions for the bearing shell parts, which results in a further optimization of the coefficient of friction.

Furthermore, it can be a significant advantage if at least one bearing shell part as a whole is composed of a metallic material or contains metal. The friction can be greatly minimized due to such an embodiment. In addition, a ball joint formed in this manner is able to absorb higher loads than conventional types of constructions. In particular, the “breakaway torques” that have proven to be problematic with ball joints in motor vehicles, and that can arise between the friction surfaces of the bearing shell and joint ball, particularly after long rest times of a ball joint, are avoidable with such an embodiment. Thus, also the service life of a thusly equipped ball joint can be significantly improved, because the mentioned breakaway torques, in particular, lead to increased wear, and with it the danger of a premature failure of the ball joint. The bearing shell part remains elastic also as a metal part, in particular, due to the blanking of the metallic layer of the bearing shell part.

An additional very advantageous solution is further that the bearing shell part having the metal strip is composed of a compound material, and has at least one plastic layer. In this regard, the positive damping properties of a plastic and its tolerance compensating properties can be combined in a very advantageous manner having the previously named elasticity and strength of the metallic band. In this context, it is possible to provide one or more plastic layers. Consequently, the metallic band can be embedded between two plastic layers, for example. Another variant embodiment is that the metallic band, with one of its surfaces, comes in direct contact with the corresponding inner surface of the housing. Following this idea of the invention, all bearing shell parts can also be composed of different materials or material compositions.

It is particularly advantageous if the bearing shell parts are each inserted into the housing under axial and/or radial preload force. The orientation of the preload force is aligned in an axial or radial direction depending on the embodiment of the corresponding ball joint. Here too, axial joints and radial joints are distinguished. The preload force applied to the bearing shell or bearing shell parts enables later the compensation of the forces acting on the ball joint in the scope of the already present preload force.

An additional increase of the elasticity of the ball joint according to the invention and the bearing shell contained therein, can be attained in that a spacing or gap spacing in the sense of a slit is present in the fully assembled ball joint at the bearing shell part having the metal strip. The slit is used according to the invention to enable compensation of the movement of the bearing shell with respect to the ball pin.

The slit according to the invention can have a gap spacing of between 0.3 and 0.7 millimeters. A preferred gap spacing, however, is 0.5 millimeters. With this, optimal elasticity values have emerged for a bearing shell according to the invention.

For improved compensation of the forces introduced into the ball joint via the ball pin, it is further advantageous if the bearing shell is implemented to be elastic and at least one bearing shell part has a conical contact surface with which this is supported at a corresponding inner surface of the housing. Due to the conical design of the contact surfaces of the bearing shell and the housing that correspond to each other, forces both in the axial and also the radial direction can be optimally absorbed. A joint of this type can be designed both as an axial joint as well as a radial joint.

The method according to the invention for producing a ball joint has at least the following method steps:
producing a band-shaped bearing shell blank comprised of a metal strip,
introducing a prong-like or tooth-like contour into one longitudinal side of the bearing shell blank by means of a separation process, so that the bearing shell blank has the geometry of an unrolling of the bearing shell,
forming the bearing shell blank so that a bearing shell having a ball-shaped bearing surface, or a bearing shell part having a ball-shaped bearing surface is formed.

The specified method is very simple to implement in terms of production engineering and furthermore enables the provision of bearing shells that can be designed optimally and load-independent. The prong-like or tooth-like contour of one longitudinal side of the bearing shell blank enables, in the completed bearing shell, an additional improvement of the elastic properties of this bearing shell.

According to one design of this invention, the creation of the bearing shell blanks can occur at least partly by punching. The use of a punching process makes it possible to have a very short cycle time for the production of the bearing shell blanks.

The punch process or a blanking process can be used both for creating perforations as well as also for producing the prong-like or tooth-like contour. Furthermore, it is conceivable to produce a bearing shell blank according to the invention as a whole and in one work step using a punch process or a blanking process.

Blanking in particular can be performed with high precision so that even structurally small dimensions, as they occur in the present case in the production of a bearing shell, can be implemented. Therefore, such manufacturing processes can be applied particularly advantageously in the present case.

A rolling process can be used for forming the bearing shell blank and the formation of a ball-shaped bearing shell or a ball-shaped bearing shell part. By using the rolling process, the ball-shaped contour of the bearing surface of the bearing shell or bearing shell part can be created optimally and with high precision.

As initially mentioned, it is advantageous if during the assembly of the ball joint a preload force is introduced on the bearing shell. In the fully assembled ball joint, the preload force permits, at least to a limited extent, the compensation of the forces introduced into the bearing shell by the ball pin, and has a tolerance compensating effect.

In order to be able to define the coefficient of friction and the resulting breakaway torque in advance as precisely as possible, it is further proposed that during the assembly of the components of the ball joint, the torques required for moving the ball pin within the bearing shell are measured in defined intervals, and that the ball joint is closed only upon attaining a predefined torque, so that the last recorded torque is preserved. In this way, the coefficients of friction and the torques occurring within the ball joint can be reliably set, and also constructed repeatably for mass production. The ball joints created in this manner have a uniform quality.

The invention is described in the following in more detail based on the attached drawings. The example embodiments shown do not limit the invention to the variants shown, but rather serve merely for explaining the principle of the invention. In order to be able to illustrate the function according to the invention, only very simplified schematic representations are shown in the figures in which components that are not essential to the invention have been omitted. This does not imply, however, that such components would not be present in a solution according to the invention.

### BRIEF DESCRIPTION OF THE DRAWINGS

The drawings show:

FIG. 1 a cut-away perspective view of a ball joint according to the invention,

FIGS. 2a-2c a sequence plan for producing a bearing shell component,

FIG. 3 a section of a partial section through a first variant embodiment of a bearing shell constructed to have multiple layers, and

FIG. 4 a section of a second variant of a bearing shell constructed to have multiple layers shown in section.

### DETAILED DESCRIPTION OF THE DRAWINGS

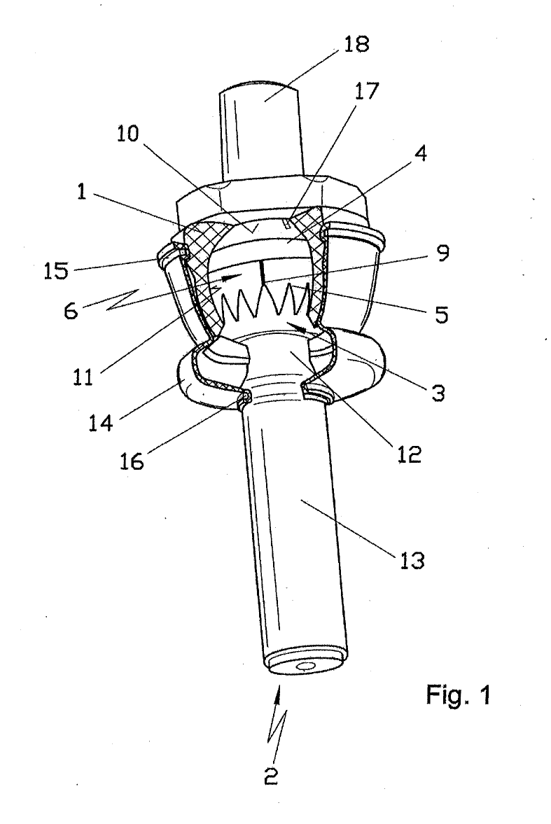

FIG. 1 shows a ball joint in a spatial view, in which the present ball joint is an axial joint. The ball joint has a housing 1 in which a ball pin 2 is pivotably and rotatably supported. The bearing of the ball pin 2 in the housing 1 occurs using a joint ball 3 formed on the ball pin. This joint ball 3 is received in a bearing shell designated as a whole with 6. The bearing shell 6 in the ball joint shown in FIG. 1, consists of two bearing shell parts 4 and 5. The bearing shell part 4 in the example embodiment was produced from a plastic of limited elasticity, whereas the bearing shell part 5 is composed of a metallic material, or has a metal strip 7. Because the metal strip 7 is produced by a rolling process, and thus is formed to a ball-shaped contour of the bearing shell part 5, the bearing shell part 5 has a gap spacing 9 which forms a slit 9 in the bearing shell part 5. The bearing shell part 4, above in FIG. 1, composed of plastic, additionally has a contact surface 10 which is cone-shaped. This contact surface 10 corresponds to a cone-shaped contact surface of the inner surface 11 of the housing 1. The contact surface 10 of the bearing shell part 4 abuts directly on this inner surface 11 of the housing 1. In addition, slits 17 are present in the bearing shell part 4 which improve the elasticity of the bearing shell part 4.

In the transition area between the joint ball 3 and a pin section 13 of the ball pin 2, the latter has a ball pin shaft 12. The ball pin shaft 12 is reduced in its cross section compared to the pin section 13 and has a groove-like, curved contour. For sealing the inner joint components against the penetration of impurities or moisture, the ball joint has a bellows seal 14. This is fastened to the outer surface of the housing 1 by means of a clamping ring 15. The opposite end of the bellow seal 14 is fasted at the pin section 13 of the ball pin 2 using a clamping ring 16. Because the represented ball joint is an axial joint, it has, for fastening in a motor vehicle, a housing pin 18 which is located on the housing 1 on the side of the ball joint opposite from the pin section 13, and which can have a connection thread.

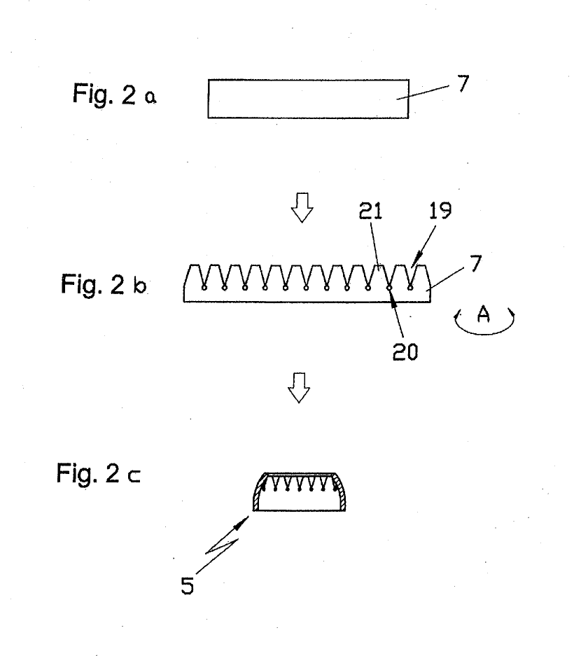

FIGS. 2a-2c show a sequence plan composed of individual phases for producing a bearing shell part 5. According to that, initially a bearing shell blank is produced from a metallic band or metal strip 7. The latter has a rectangular geometry which arises from the FIG. 2a.

Following this, in a further manufacturing step shown in FIG. 2b, holes 20 with uniform spacing to each other are introduced into the metal strip 7. Then, using a blanking or punching, recesses or notches 19 are introduced on one side of the metal strip 7, which consequently receives a prong-like or tooth-like contour on one side. FIG. 2b further shows an arrow A that indicates the subsequent forming of the metal strip 7 into a bearing shell part 5. This forming in the present case occurs using a rolling process. For the purpose of simplification, the rolling tool is not represented here.

FIG. 2c shows an example bearing shell part 5 in section, as it can appear in the finished state. This has the usual contour of the bearing shell of a ball joint.

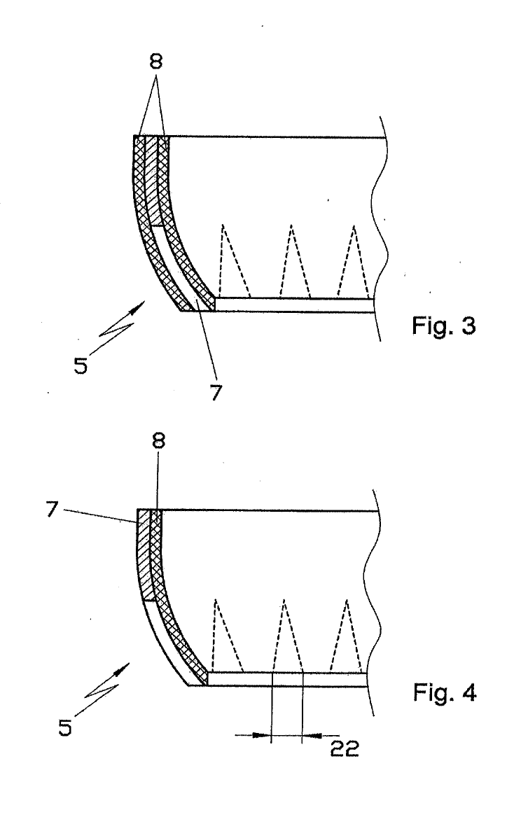

FIG. 3 shows a first variant embodiment of a bearing shell part 5. The distinguishing feature of the bearing shell part 5 shown in part in the section represented in FIG. 3 consists in that this has a metal strip band 7 that, at its inner and outer peripheral surfaces, is completely encased by a plastic layer 8.

In contrast to the representation in FIG. 3, the bearing shell according to FIG. 4 only has one plastic layer 8. This is connected to the metal strip 7 and is present on the inside of the bearing shell part 5.

In a further example embodiment, not shown, the position of the metal strip 7 and the plastic layer can be reversed.

The spacing 22 shown in FIG. 4, shows the spacing of the ends of the prongs or teeth in the installed state.

### LIST OF REFERENCE SYMBOLS

53 Housing
54 Ball pin
55 Joint ball
56 Bearing shell part
57 Bearing shell part
58 Bearing shell
59 Metallic band/layer, metal strip (bearing shell blank)
60 Plastic layer
61 Gap spacing, spacing, slit
62 Contact surface
63 Inner surface of the housing
64 Ball pin shaft
65 Pin section with attachment thread
66 Bellows seal
67 Clamping ring
68 Clamping ring
69 Slit
70 Housing pin
71 Recess, notch
72 Bore hole
73 Prongs, teeth
74 Spacing

1-13. (canceled)

14. A ball joint for a motor vehicle comprising:
a housing (1),
a ball pin (2), and
a joint ball (3) being rotatably and pivotably supported in a bearing shell (6), the bearing shell (6) being is provided with recesses, and, for the formation of either the bearing shell or a component of the bearing shell, contains formed metal strips (7).

15. The ball joint according to claim 14, wherein one of prongs and teeth are formed by the recesses (19) on at least one side of the bearing shell and, after installation of the bearing shell into the ball joint, ends of the one of the prongs and the teeth are aligned inward toward a central axis of the ball pin and are spaced from one another.

16. The ball joint according to claim 14, wherein the recesses are V-shaped.

17. The ball joint according to claim 15, wherein the one of the teeth and the prongs have a trapezoid shape.

18. The ball joint according to claim 15, wherein one of a ratio of a depth to a width of the recesses and or spacing of the one of the prongs and the teeth from one another is approximately ⅔ to ⅓.

19. The ball joint according to claim 14, wherein ends of the metal strip of the bearing shell are spaced from one another by a slit (9).

20. The ball joint according to claim 19, wherein the slit (9) is between 0.3 and 0.7 mm wide.

21. The ball joint according to claim 19, wherein the slit (9) is 0.5 mm wide.

22. The ball joint according to claim 14, wherein bearing shell parts (4, 5) comprise one different materials and different material compositions.

23. The ball joint according to claim 14, wherein the bearing shell (6) comprises of a plurality of bearing shell parts (4, 5) and at least one bearing shell part (4, 5) comprises metal.

24. The ball joint according to claim 23, wherein one bearing shell part (4, 5) composes a composite material and is formed from a metal strip (7) having at least one plastic layer (8).

25. The ball joint according to claim 14, wherein at least one bearing shell part (4, 5) has a cone-shaped contact surface (10) with which the at least one bearing shell part (4, 5) is supported at a corresponding inner surface (11) of the housing (1).

26. A method of producing a component of a ball joint bearing shell of a ball joint for a motor vehicle comprising: a housing (1), a ball pin (2), and a joint ball (3) that is rotatably and pivotably supported in the bearing shell (6), the bearing shell (6) being provided with recesses, and, for the formation of either the bearing shell or a component of the bearing shell, contains formed metal strips (7), and the method comprising the steps of:
producing a band-shaped bearing shell blank from a metal strip (7);
inserting one of a prong-like and a tooth-like contour into one longitudinal side of the bearing shell blank (7) by a separation process, such that the bearing shell blank (7) has a geometry of an unrolling of the bearing shell (6); and
forming the bearing shell blank (7) such that the bearing shell (6) has either a ball-shaped bearing surface or a bearing shell part (4, 5) having a ball-shaped bearing surface.

27. A ball joint for a motor vehicle comprising:
a housing (1),
a ball pin (2), and
a joint ball (3) being rotatably and pivotably supported within a bearing shell (6), the bearing shell (6) comprising recesses and being formed from a metal strip (7).
